(19) United States
(12) Patent Application Publication
(10) Pub. No.: US 2012/0318799 A1
(43) Pub. Date: Dec. 20, 2012

(54) DRAINABLE CONTAINER SYSTEM AND WELD NUT THEREOF

(75) Inventors: Thomas A. Spix, Rochester Hills, MI (US); Karl R. Gilgenbach, Rochester Hills, MI (US)

(73) Assignee: GM GLOBAL TECHNOLOGY OPERATIONS LLC, Detroit, MI (US)

(21) Appl. No.: 13/160,602

(22) Filed: Jun. 15, 2011

(51) Int. Cl. F01M 11/04; F16B 37/06; F16B 37/04; B65D 41/04; B65D 53/00

(52) U.S. Cl. 220/304; 220/288; 411/171

(57) ABSTRACT

A drainable container system for a vehicle includes a container defining an interior cavity configured for storing a fluid, and a drain hole configured for draining the fluid from the interior cavity. The drainable container system further includes a drain plug configured for plugging the drain hole, and a weld nut attachable to the container and configured for receiving the drain plug. The weld nut includes a coupling portion matable with the drain plug and having a longitudinal axis, and a flange portion extending from the coupling portion and disposed substantially perpendicular to the longitudinal axis. The flange portion defines at least one channel therein configured for conducting the fluid to the drain hole.

### TECHNICAL FIELD

The present disclosure generally relates to drainable container systems for vehicles.

### BACKGROUND

Vehicles generally include drainable containers that are configured for storing a fluid. For example, drainable containers such as oil pans and other fluid reservoirs may store engine oil, differential gear lubricants, transmission fluid, and the like. Such fluids typically become contaminated and/or depleted during operation of the vehicle, and must therefore be replenished and/or refreshed periodically.

Accordingly, such drainable containers often include a drain hole for draining the fluid from the drainable container during fluid change-out operations. During such fluid change-out operations, residual fluid that does not drain through the drain hole, but rather remains within the drainable container, may contaminate the newly replenished and/or refreshed fluid.

### SUMMARY

A drainable container system includes a container defining an interior cavity configured for storing a fluid, and a drain hole configured for draining the fluid from the interior cavity. The drainable container system also includes a drain plug configured for plugging the drain hole, and a weld nut attachable to the container and configured for receiving the drain plug. The weld nut includes a coupling portion matable with the drain plug and having a longitudinal axis, and a flange portion extending from the coupling portion and disposed substantially perpendicular to the longitudinal axis. The flange portion defines at least one channel therein configured for conducting the fluid to the drain hole.

In one embodiment, the coupling portion has an end surface and defines a central bore therethrough along the longitudinal axis. The flange portion is disposed substantially perpendicular to the longitudinal axis, and has a first surface attachable to the container, a second surface spaced opposite and apart from the first surface and abutting the coupling portion, and a plurality of outer edge surfaces each spaced apart from the central bore and connecting the first surface and the second surface. The flange portion defines a plurality of channels therein each radiating from a respective one of the plurality of outer edge surfaces to the central bore. Further, the container has a third surface substantially parallel to the first surface and the second surface and configured for abutting the first surface. The container also has a residual fluid zone within the interior cavity having a height equal to a distance between the end surface at the central bore and the third surface at the drain hole. Each of the plurality of channels is configured for conducting the fluid within the residual fluid zone to the drain hole.

A weld nut configured for receiving a drain plug insertable into a drain hole of a container, wherein the container defines an interior cavity for storing fluid therein, includes a coupling portion matable with the drain plug and having a longitudinal axis, and a flange portion extending from the coupling portion and disposed substantially perpendicular to the longitudinal axis. The flange portion defines at least one channel therein configured for conducting the fluid to the drain hole.

The above features and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic cross-sectional illustration of a drainable container system for a vehicle, including a weld nut attached to a container, and a drain plug inserted into the weld nut;

FIG. 2 is a schematic perspective illustration of a flange portion of the weld nut of FIG. 1;

FIG. 3 is a schematic perspective illustration of a coupling portion of the weld nut of FIGS. 1 and 2; and

FIG. 4 is a schematic cross-sectional illustration of the container and weld nut of FIG. 1, wherein the drain plug is removed from the weld nut.

### DETAILED DESCRIPTION

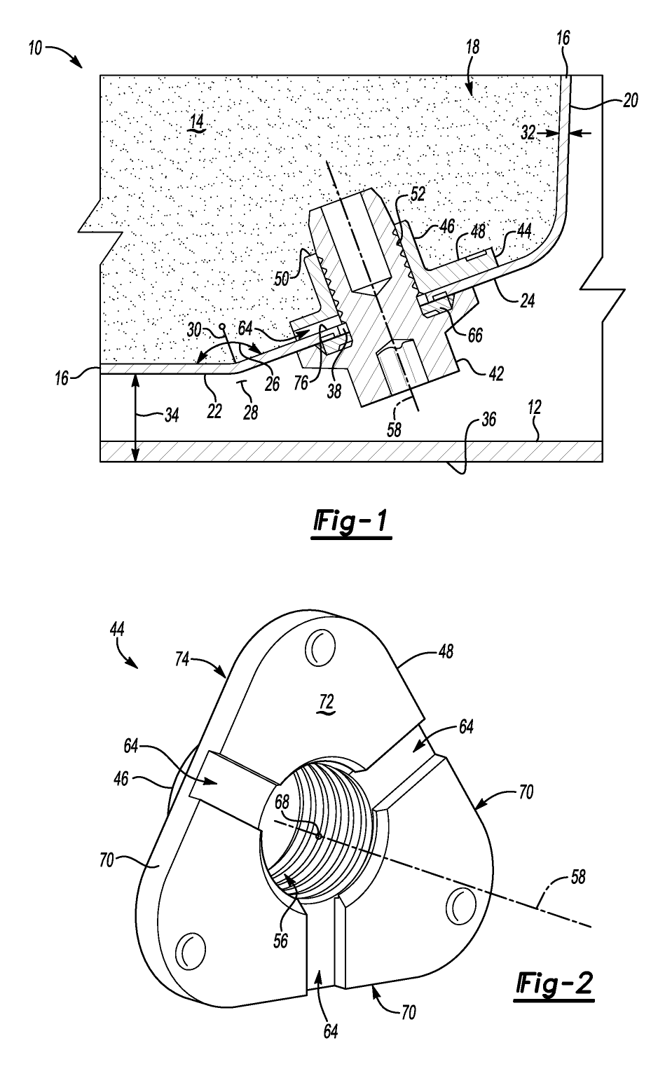

Referring to the Figures, wherein like reference numerals refer to like elements, a drainable container system 10 for a vehicle 12 is shown generally in FIG. 1. The drainable container system 10 may be useful for storing fluid 14 necessary for operation of the vehicle 12. More specifically, the drainable container system 10 may be useful for draining a substantial entirety of the fluid 14 during fluid change-out operations required for maintenance of the vehicle 12. Therefore, the drainable container system 10 may be useful for automotive applications such as, for example, oil pans, differential gear lubricant housings, and other fluid reservoirs for vehicles 12. However, the drainable container system 10 may also be useful for fluid reservoirs for non-automotive applications including, but not limited to, recreational vehicles, agricultural vehicles, and lawnmowers.

Referring to FIG. 1, the drainable container system 10 includes a container 16 defining an interior cavity 18 configured for storing the fluid 14. The container 16 may be any fluid reservoir and the interior cavity 18 may store any fluid 14. For example, the container 16 may be an oil pan of an automotive vehicle 12 and may be configured for storing engine oil. Alternatively, the container 16 may be a differential gear housing of an automotive vehicle 12 and may be configured for storing gear lubricant.

As shown in FIG. 1, the container 16 may include a wall portion 20, a horizontal pan portion 22 spaced apart from and substantially perpendicular to the wall portion 20, and a seal surface portion 24 interconnecting and integral with the wall portion 20 and the horizontal pan portion 22. Further, the horizontal pan portion 22 and the seal surface portion 24 may define an angle 26 therebetween of greater than about 90°. For example, the horizontal pan portion 22 and the seal surface portion 24 may define the angle 26 therebetween of from about 130° to about 180°. Stated differently, the seal surface portion 24 may be angled with respect to each of the wall portion 20 and the horizontal pan portion 22 to define a bend 28 having a radius 30 of from about 5 mm to about 15 mm.

With continued reference to FIG. 1, the container 16 may have a thickness 32 of from about 1 mm to about 1.5 mm, e.g., about 1.2 mm. The container 16 may be formed from any suitable material, e.g., metal, plastic, composites, and combinations thereof. In one example, the container 16 may be an oil pan and may be formed from steel. Further, the container 16 may be disposed within the vehicle 12 at a distance 34 of from about 10 mm to about 20 mm from a frame 36 of the vehicle 12. That is, there may be from about 10 mm to about 20 mm of clearance between the frame 36 of the vehicle 12 and a bottom of the container 16.

With continued reference to FIG. 1, the fluid 14 may be disposed within the interior cavity 18. That is, the container 16 may contain and store the fluid 14 for use during operation of the vehicle 12. By way of non-limiting examples, the fluid 14 may be engine oil, transmission fluid, gear lubricant, water, or any liquid suitable for operation of the vehicle 12. The vehicle 12 may consume and/or contaminate the fluid 14 during vehicle operation. For example, for the variation including engine oil, the fluid 14 may be recirculated throughout an engine (not shown) of the vehicle 12 and may become contaminated with sludge and deposits, and/or may thermally degrade during operation of the vehicle 12. As such, the fluid 14 may require periodic draining from the interior cavity 18 during fluid change-out operations.

Therefore, as best shown in FIG. 4, the container 16 also defines a drain hole 38 configured for draining the fluid 14 from the interior cavity 18. The drain hole 38 may have a first diameter 40 of from about 12 mm to about 15 mm, e.g., about 13.5 mm, and may be defined by the seal surface portion 24 of the container 16.

Referring again to FIG. 1, the drainable container system 10 also includes a drain plug 42 configured for plugging the drain hole 38. That is, the drain plug 42 may be inserted into the drain hole 38 during operation of the vehicle 12 so as to plug or seal off the drain hole 38 so that the fluid 14 may be stored within the interior cavity 18 of the container 16. In addition, as described with reference to FIG. 4, the drain plug 42 (FIG. 1) may be removed from the drain hole 38 during fluid change-out operations so that the fluid 14 may drain from the interior cavity 18 of the container 16.

Referring now to FIGS. 1-4, the drainable container system 10 further includes a weld nut 44 attachable to the container 16 (FIG. 1) and configured for receiving the drain plug 42 (FIG. 1). That is, as shown in FIGS. 1 and 4, the weld nut 44 may be attached, e.g., welded, to the container 16 within the interior cavity 18 and may be concentric with the drain hole 38. Therefore, the weld nut 44 may be attached to the seal surface portion 24 of the container 16 within the interior cavity 18. The weld nut 44 may be formed from any material suitable for contact with the fluid 14. For example, the weld nut 44 may be formed from a metal such as, but not limited to, steel. Further, the weld nut 44 may be formed via a cold heading forming operation in which a slug (not shown) of material is plastically deformed within a die cavity (not shown). Since the die cavity may be re-used to produce multiple weld nuts 44, the weld nut 44 is economical to manufacture.

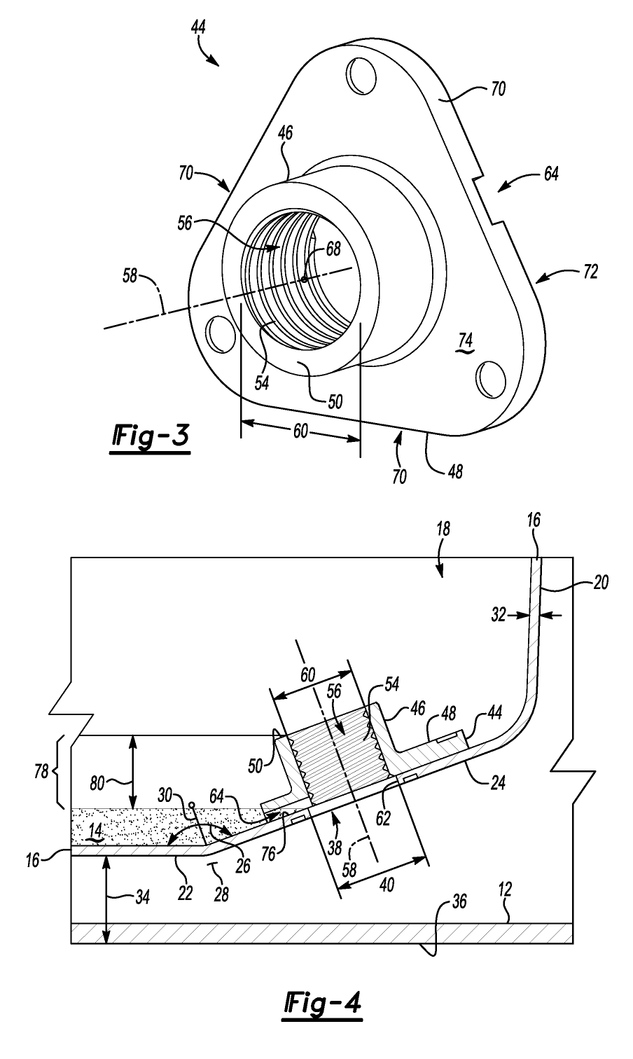

As best shown in FIG. 3, the weld nut 44 includes a coupling portion 46 matable with the drain plug 42 (FIG. 1) and having a longitudinal axis 58, and a flange portion 48 extending from the coupling portion 46 and disposed substantially perpendicular to the longitudinal axis 58. The coupling portion 46 may be integral with the flange portion 48, have an end surface 50, and may extend perpendicularly from the flange portion 48.

With continued reference to FIGS. 1 and 3, the coupling portion 46 (FIG. 3) may mate with the drain plug 42 (FIG. 1) in any manner. For example, as shown in FIGS. 1 and 4, the coupling portion 46 may be threadably matable with the drain plug 42 (FIG. 1). That is, the drain plug 42 may include a helical thread 52 (FIG. 1) thereon, and the coupling portion 46 may define a groove 54 (FIG. 3) therein matable with the helical thread 52. Therefore, to plug the drain hole 38 (FIG. 4) so that the fluid 14 is contained within the interior cavity 18 of the container 16, the drain plug 42 (FIG. 1) may be inserted into and threaded onto the coupling portion 46 so as to mate with the weld nut 44, as shown in FIG. 1.

Referring again to FIG. 3, the coupling portion 46 may define only a central bore 56 therethrough along the longitudinal axis 58. That is, the coupling portion 46 may define no other apertures therethrough. For example, the coupling portion 46 may be solid and annular, and may define no other holes, channels, saw cuts, or voids therethrough the groove 54. As such, the coupling portion 46 is sturdy and not subject to collapse upon insertion of the drain plug 42. As best shown in FIGS. 2 and 3, the central bore 56 is defined along the longitudinal axis 58 and substantially perpendicular to the flange portion 48. Further, as best shown in FIGS. 3 and 4, the central bore 56 may have a second diameter 60 that is less than the first diameter 40 (FIG. 4). Therefore, the coupling portion 46 may not abut or obstruct the drain hole 38 defined by the container edge 62 (FIG. 4) at the seal surface portion 24 when the drain plug 42 is inserted into the drain hole 38.

Referring now to FIGS. 2 and 3, the flange portion 48 defines at least one channel 64 therein configured for conducting the fluid 14 (FIG. 1) to the drain hole 38 (FIG. 4). The at least one channel 64 may be rectangular and may intersect the central bore 56, and may be configured for channeling the fluid 14 (FIG. 1) within the interior cavity 18 (FIG. 1) along the horizontal pan portion 22 (FIG. 1) to the drain hole 38 (FIG. 1) during fluid change-out operations, as set forth in more detail below. Therefore, as best shown in FIGS. 1 and 4, the drain plug 42 (FIG. 1) may be removably insertable into the coupling portion 46 to seal off fluid communication between the at least one channel 64 and the drain hole 38, as set forth in more detail below.

Referring again to FIG. 1, the drainable container system 10 may also include a sealing element 66 disposable between the drain plug 42 and the container 16. The sealing element 66 may be formed from, for example, an elastomeric material such as rubber, and may seal the drain plug 42 against the container 16 when the drain plug 42 is mated to the coupling portion 46 so as to minimize leakage of the fluid 14 from the interior cavity 18.

Referring again to FIGS. 2 and 3, in one variation, the flange portion 48 may define a plurality of channels 64 therein. For example, as best shown in FIG. 2, the flange portion 48 may define exactly three channels 64 therein. Therefore, the flange portion 48 may have an equilateral triangle shape and include a center 68, e.g., along the longitudinal axis 58, and three outer edge surfaces 70 spaced apart from the center 68. Each of the exactly three channels 64 may radiate from the center 68 to a respective outer edge surface 70 and may be equally spaced from the two adjacent channels 64. Therefore, the weld nut 44 may be symmetrical to enable simple alignment or orientation within the interior cavity 18 (FIG. 1).

As shown in FIGS. 2 and 3, in this variation, the flange portion 48 has a first surface 72 attachable to the container 16 (FIG. 1), e.g., the seal surface portion 24 (FIG. 1), and a second surface 74 spaced opposite and apart from the first surface 72. That is, the second surface 74 is substantially parallel to the first surface 72 and abuts or joins the coupling portion 46. Further, the flange portion 48 has a plurality of outer edge surfaces 70 each spaced apart from the central bore 56 and connecting the first surface 72 and the second surface 74. With continued reference to FIGS. 2 and 3, each of the plurality of channels 64 radiates from a respective one of the plurality of outer edge surfaces 70 to the central bore 56.

Referring now to FIG. 4, the container 16 has a third surface 76 substantially parallel to the first surface 72 (FIGS. 2 and 3) and the second surface 74 (FIGS. 2 and 3) and configured for abutting the first surface 72. Further, the container 16 has a residual fluid zone 78 within the interior cavity 18 having a height 80 equal to a distance between the end surface 50 at the central bore 56 and the third surface 76 at the drain hole 38. Each of the plurality of channels 64 is configured for conducting the fluid 14 within the residual fluid zone 78 to the drain hole 38 to thereby expedite the drainage of fluid 14 from the interior cavity 18. That is, during fluid change-out operations, fluid 14 within the residual fluid zone 78 that would otherwise remain within the interior cavity 18 and not drain from the container 16 through the central bore 56 to the drain hole 38, is instead conducted through the plurality of channels 64 from the interior cavity 18 to the drain hole 38. Stated differently, as described with reference to FIG. 4, the drain plug 42 (FIG. 1) may be removable from the coupling portion 46 along the longitudinal axis 58 so that the drain hole 38 and the plurality of channels 64 are disposed in fluid communication so that the fluid 14 may drain from the interior cavity 18 through the drain hole 38. Conversely, as described with reference to FIG. 1, the drain plug 42 may be insertable into the coupling portion 46 along the longitudinal axis 58 so that the drain hole 38 and the plurality of channels 64 are not disposed in fluid communication so that the fluid 14 may be contained and stored within the interior cavity 18.

Therefore, with continued reference to FIG. 4, a comparative drainable container system (not shown) that does not include the at least one channel 64 of the present disclosure would, upon draining, retain fluid 14 at a level horizontally even with a lowermost level of the central bore 56, i.e., the end surface 50 of the coupling portion 46. That is, the comparative drainable container system (not shown) does not drain fluid 14 from the residual fluid zone 78, and as such, retains comparatively more fluid 14 within the interior cavity 18 during fluid change-out operations.

In contrast, the drainable container system 10 allows draining of a substantial entirety of the fluid 14 within the interior cavity 18 during fluid change-out operations. In particular, the drainable container assembly 10 and weld nut 44 allow greater than or equal to about 95 parts by volume, e.g., greater than or equal to about 97 parts by volume, of the fluid 14 based on 100 parts by volume of the fluid 14 within the interior cavity 18 to be drained through the drain hole 38 when the drain plug 42 is removed from the weld nut 44. As such, the drainable container system 10 and weld nut 44 minimize residual fluid 14 within the interior cavity 18 of the container 16 during fluid change-out operations for the vehicle 12. That is, the drainable container system 10 and weld nut 44 allow substantially all of the fluid 14 to be drained from the interior cavity 18 of the container 16. Therefore, the drainable container system 10 and weld nut 44 extend fluid operating life since replenished fluid is subject to minimal contamination from residual fluid within the interior cavity 18 of the container 16 during fluid change-out. In addition, the drainable container system 10 and weld nut 44 do not require relocation of the container 16 within the vehicle 12, e.g., moving or raising the container 16 to be beyond the frame 36.

While the best modes for carrying out the disclosure have been described in detail, those familiar with the art to which this disclosure relates will recognize various alternative designs and embodiments for practicing the disclosure within the scope of the appended claims.

1. A drainable container system for a vehicle, the drainable container system comprising:
a container defining;
an interior cavity configured for storing a fluid; and
a drain hole configured for draining said fluid from said interior cavity;
a drain plug configured for plugging said drain hole; and
a weld nut attachable to said container and configured for receiving said drain plug, wherein said weld nut includes;
a coupling portion matable with said drain plug and having a longitudinal axis; and
a flange portion extending from said coupling portion and disposed substantially perpendicular to said longitudinal axis, wherein said flange portion defines at least one channel therein configured for conducting said fluid to said drain hole.

2. The drainable container system of claim 1, wherein said coupling portion is integral with said flange portion and defines only a central bore therethrough along said longitudinal axis.

3. The drainable container system of claim 2, wherein said coupling portion defines no other apertures therethrough.

4. The drainable container system of claim 1, wherein said flange portion defines a plurality of channels therein.

5. The drainable container system of claim 4, wherein said flange portion defines exactly three channels therein.

6. The drainable container system of claim 5, wherein said flange portion has an equilateral triangle shape and includes a center and three outer edge surfaces spaced apart from said center, and further wherein each of said exactly three channels radiates from said center to a respective outer edge surface and is equally spaced from said two adjacent channels.

7. The drainable container system of claim 1, wherein said drain hole has a first diameter, and further wherein said coupling portion is annular and defines a central bore therethrough along said longitudinal axis having a second diameter that is less than said first diameter.

8. The drainable container system of claim 7, wherein said at least one channel intersects said central bore.

9. The drainable container system of claim 8, wherein said at least one channel is rectangular.

10. The drainable container system of claim 7, wherein said weld nut is attached to said container within said interior cavity and is concentric with said drain hole.

11. The drainable container system of claim 10, wherein said drain plug is removably insertable into said coupling portion to seal off fluid communication between said at least one channel and said drain hole.

12. The drainable container system of claim 11, wherein said drain plug includes a helical thread thereon, and further wherein said coupling portion defines a groove therein matable with said helical thread.

13. The drainable container system of claim 1, wherein said container includes a wall portion, a horizontal pan portion spaced apart from and substantially perpendicular to said wall portion, and a seal surface portion interconnecting and integral with said wall portion and said horizontal pan portion.

14. The drainable container system of claim 13, wherein said horizontal pan portion and said seal surface portion define an angle therebetween of greater than about 90°.

15. The drainable container system of claim 14, wherein said weld nut is attached to said seal surface portion within said interior cavity.

16. The drainable container system of claim 1, further including a sealing element disposable between said drain plug and said container.

17. A drainable container system comprising:
a container defining;
an interior cavity configured for storing a fluid; and
a drain hole configured for draining said fluid from said interior cavity;
a drain plug configured for plugging said drain hole; and
a weld nut attachable to said container and configured for receiving said drain plug, wherein said weld nut includes;
a coupling portion matable with said drain plug having an end surface and a longitudinal axis, and defining a central bore therethrough along said longitudinal axis; and
a flange portion extending from said coupling portion and disposed substantially perpendicular to said longitudinal axis, wherein said flange portion has;
a first surface attachable to said container;
a second surface spaced opposite and apart from said first surface and abutting said coupling portion; and
a plurality of outer edge surfaces each spaced apart from said central bore and connecting said first surface and said second surface;
wherein said flange portion defines a plurality of channels therein each radiating from a respective one of said plurality of outer edge surfaces to said central bore;
wherein said container has a third surface substantially parallel to said first surface and said second surface and configured for abutting said first surface;
wherein said container has a residual fluid zone within said interior cavity having a height equal to a distance between said end surface at said central bore and said third surface at said drain hole;
wherein each of said plurality of channels is configured for conducting said fluid within said residual fluid zone to said drain hole.

18. The drainable container system of claim 17, wherein said drain plug is insertable into said coupling portion along said longitudinal axis so that said drain hole and said plurality of channels are not disposed in fluid communication, and further wherein said drain plug is removable from said coupling portion along said longitudinal axis so that said drain hole and said plurality of channels are disposed in fluid communication.

19. A weld nut configured for receiving a drain plug insertable into a drain hole of a container, wherein the container defines an interior cavity configured for storing fluid therein, the weld nut comprising:
a coupling portion matable with the drain plug and having a longitudinal axis; and
a flange portion extending from said coupling portion and disposed substantially perpendicular to said longitudinal axis, wherein said flange portion defines at least one channel therein configured for conducting the fluid to the drain hole.

20. The weld nut of claim 19, wherein said coupling portion defines only a central bore therethrough along said longitudinal axis and substantially perpendicular to said flange portion, and wherein said coupling portion defines no other apertures therethrough.
